(19) United States
(12) Patent Application Publication
(10) Pub. No.: US 2021/0073734 A1
(43) Pub. Date: Mar. 11, 2021

(54) METHODS AND SYSTEMS OF ROUTE OPTIMIZATION FOR LOAD TRANSPORT

(71) Applicants: SYED AMAN, santa clara, CA (US); SHARANJEET SINGH GREWAL, san ramo, CA (US); ZAHED KHAN, los angeles, CA (US)

(72) Inventors: SYED AMAN, santa clara, CA (US); SHARANJEET SINGH GREWAL, san ramo, CA (US); ZAHED KHAN, los angeles, CA (US)

(21) Appl. No.: 16/929,111

(22) Filed: Jul. 15, 2020

Related U.S. Application Data
(60) Provisional application No. 62/875,174, filed on Jul. 17, 2019.

(51) Int. Cl. G06Q 10/08

(52) U.S. Cl. CPC G06Q 10/08355

(57) ABSTRACT

In one aspect, method comprises the step of receiving a current geo-location of a driver's device. The method includes the step of determining a set of available loads for a driver to haul on a specified route. The method include the step of using the set of available loads as a set of starting waypoints for a multi trip itinerary to determine a subset of loads of the set of available loads. The method comprises the step of providing a set of Driving Time Criterion (DTC) and Weather Criterion (WCL) constraints. The method comprises the step of calculating a driving time for the driver to reach a specified destination waypoint based on the set of DTC and WCL constraints. The method comprises the step of determining all loads available for which the driver is able to perform an on time pickup and on time to drop off within the set of DTC and WCL constraints. The method comprises the step of generating an optimized route of a multi-trip itinerary for the driver to follow to perform the on time pickup and on time to drop off within the set of DTC and WCL constraints.

### CLAIM OF PRIORITY

This application claims priority to U.S. Provisional Patent Application No. 62/875,174, filed on 17 Jul. 2019, and titled METHODS AND SYSTEMS OF ROUTE OPTIMIZATION FOR LOAD TRANSPORT. This provisional application is hereby incorporated by reference in its entirety.

### BACKGROUND

Currently, about twenty to thirty percent of miles driven in the trucking industry are empty miles (e.g. no load or an insufficient load, etc.). There is also a driver shortage problem of the trucking industry. In one example, the driver shortage is projected to be more than one hundred thousand drivers.

As the same time, improvements to data science and machine learning are available to automate multi-trip-itinerary planning for truck drivers. These can be used to increase the efficiency of driver routes. Accordingly, methods of reducing empty miles by applying the rigor of data science and optimization algorithms are desired.

### SUMMARY OF THE INVENTION

In one aspect, method comprises the step of receiving a current geo-location of a driver's device. The method includes the step of determining a set of available loads for a driver to haul on a specified route. The method include the step of using the set of available loads as a set of starting waypoints for a multi trip itinerary to determine a subset of loads of the set of available loads. The method comprises the step of providing a set of Driving Time Criterion (DTC) and Weather Criterion (WCL) constraints. The method comprises the step of calculating a driving time for the driver to reach a specified destination waypoint based on the set of DTC and WCL constraints. The method comprises the step of determining all loads available for which the driver is able to perform an on time pickup and on time to drop off within the set of DTC and WCL constraints. The method comprises the step of generating an optimized route of a multi-trip itinerary for the driver to follow to perform the on time pickup and on time to drop off within the set of DTC and WCL constraints.

### BRIEF DESCRIPTION OF THE DRAWINGS

FIG. 1 illustrates an example system for multi-hop routing for container vehicles, according to some embodiments.

FIG. 2 illustrates an example process for implementing a multi-trip itinerary through multiple drivers, according to some embodiments.

FIG. 3 illustrates an example transportation logistics system, according to some embodiments.

FIG. 4 depicts an exemplary computing system that can be configured to perform any one of the processes provided herein.

FIG. 5 illustrates an example process for route optimization for load transport, according to some embodiments.

FIG. 6 illustrates another example process for route optimization for load transport, according to some embodiments.

FIG. 7 is a schematic representation of an exemplary hardware environment.

The Figures described above are a representative set and are not exhaustive with respect to embodying the invention.

### DESCRIPTION

Disclosed are a system, method, and article of route optimization for load transport. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cloud computing can involve deploying groups of remote servers and/or software networks that allow centralized data storage and online access to computer services or resources. These groups of remote serves and/or software networks can be a collection of remote computing services.

Empty mile can a mile unit of distance traveled by an empty container vehicle (e.g. in an unloaded state, etc.). In other examples, other units of distance can be utilized (e.g. nautical miles, kilometers, etc.).

Hours of Service (HOS) is a regulation and the authority for this regulation is the Federal Motor Carrier Safety Administration (FMCSA) and FMCSA govern the working hours of anyone operating a commercial motor vehicle (CMV) in the United States.

Geolocation of Driver (GLD) is the current location of the driver which system receives from either driver's device or provided to the system by the Carrier Company or a 3rd party device or a 3^{rd} party company

Load Type (LT) is the load type requested by the shipper. It can be a Drop and Hook, Reefer, Dry Van, Flat Bed, Dryage, FTL (Full Truck Load), LTL (Less Than Truck Load), Intermodal, Air, Rail, Drones, Electric Trucks or any other type of load supported by the system

Carrier's Load Type Preferences (CLTP) is the preferences set by the Carrier or Driver in the system, it refers to the type of equipment's carrier has (Reefer, Dry Van, Flat Bed) and if carrier is interested in Drop and Hook loads

Number of Days Driver Wants to Drive (NDDWD) is the preference given by Carrier or Driver when searching for single load or multi trip loads. This is the number of day's driver is willing to drive, starting with the date and time when request is received by the system or from the date and time selected by user

Minimum Rate Per Mile (MRPM) is the preference given by the Carrier or Driver when searching for single load or multi trip loads. This is the minimum rate per mile that Carrier or Driver is expecting to get paid if they choose to accept the load to haul. Rate per mile is load price divided by distance travelled by Driver from pickup location to final drop off location

Minimum Total Revenue (MTR) is the preference given by the Carrier or Driver when searching for single load or multi trip loads. This is the minimum price that Carrier or Driver is expecting to get paid if they choose to accept the load to haul

Weather Conditions at Pickup (WCP) are the weather conditions at pickup location(s) that are considered by the system to determine how they would impact the driver's ability to reach on time for load pickup

Weather Conditions at Dropoff (WCD) are the weather conditions at drop-off location(s) that are considered by the system to determine how they would impact the driver's ability to reach on time for load drop off

Weather Conditions in Route (WSR) are the weather conditions between driver's current location before pickup of load, pickup location(s) or drop off location(s) that are considered by the system to determine how they would impact the driver's ability to reach on time for either pickup or drop off

Driver's Lane Preferences (DLP)—Countries and states/provinces in which driver prefers to drive

Machine learning (ML) can use statistical techniques to give computers the ability to learn and progressively improve performance on a specific task with data, without being explicitly programmed. Deep learning is a family of machine learning methods based on learning data representations. Learning can be supervised, semi-supervised or unsupervised. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set.

Self-driving truck (e.g. an autonomous truck, robo-truck, etc.) may not require human driver, similar to self-driving cars. In some examples, a self-driving truck can be used in lieu of a driver.

Vehicle routing problem (VRP) is a combinatorial optimization and integer programming problem which asks, “What is the optimal set of routes for a fleet of vehicles to traverse in order to deliver to a given set of customers?”. This algorithm will be using a combination of multiple criteria's to come up with the right combination of loads

Example Methods

Example methods can be used to automatically generate a multi-trip itinerary based on the following criteria, inter alia: geolocation (latitude/longitude) of driver (GLD) associated with the carrier profile; load type (LT)—drop and hook, reefer, dry van, flat bed or any other type of load; carrier's load type preferences (CLTP)—type of equipment's carrier has (reefer, dry van, flat bed) and if carrier is interested in drop and hook loads; number of days driver wants to drive (NDDWD)—default 3 days (days configurable); minimum rate per mile for the entire multi trip itinerary (MRPM) and/or minimum total revenue for the entire multi trip itinerary (MTR) that a driver wishes to receive; weather conditions within a specified configurable radius (e.g. fifty (50) miles, etc.) of the load pick address (WCP); weather conditions within a specified configurable radius (e.g. fifty (50) miles, etc.) of the load drop off address (WCD); etc.

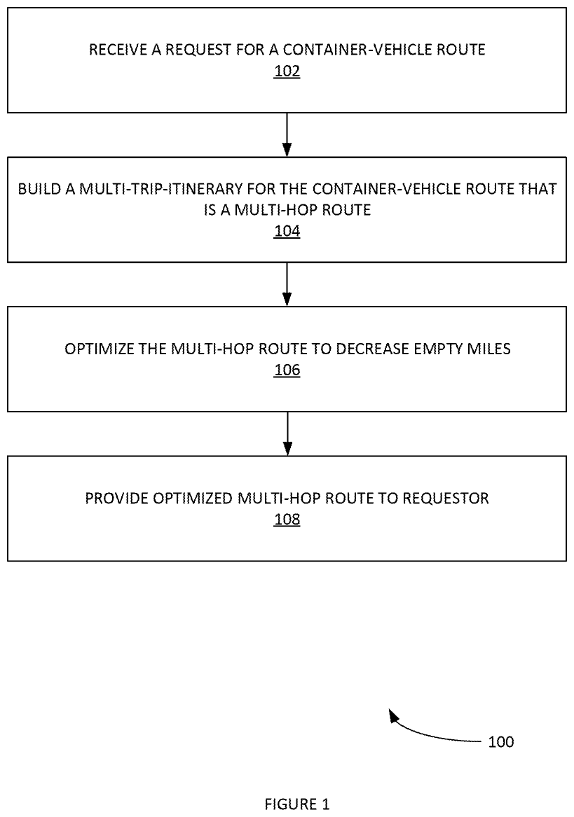

FIG. 1 illustrates an example system 100 for multi-hop routing for container vehicles, according to some embodiments. A container vehicle can be a truck, an airplane, a delivery vehicle, a container ship, autonomous vehicle, drone and the like. Process 100 can be used in reducing ‘empty miles’ logistics in trucking load routing.

In step 102, process 100 can receive a request for a container-vehicle route. In step 104, process 100 can build a multi-trip-itinerary for the container-vehicle route that is a multi-hop route. In step 106, process 100 can optimize the multi-hop route to decrease empty miles. In step 108, process 100 can provide optimized multi-hop route to requestor.

In a truck transportation example, process 100 can generate and provide a multi-trip itinerary for requesting truck drivers. For example, process 100 can build a multi-hop route from point A-to-B-to-C-to-D. In this way, a truck driver can book a block of loads (instead of just a single load at a time). Process 100 can be utilized by truck drivers to optimize on their overall revenue, reduce empty miles, etc.

In one example, process 100 can receive a set of loads (e.g. freight, cargo, etc.). Load 1 pickup from location A and drop off to location B, wherein A and B are the pickup and destination city/state respectively. Load 2 is a pickup from location B and a drop off to location C. Load 3 is a pickup from location C and drop off to location D. Load 2 is a pickup from location D and drop off to location E. In the above example, process 100 can generate a single and optimized Trip Itinerary from A to B to C to D to E.

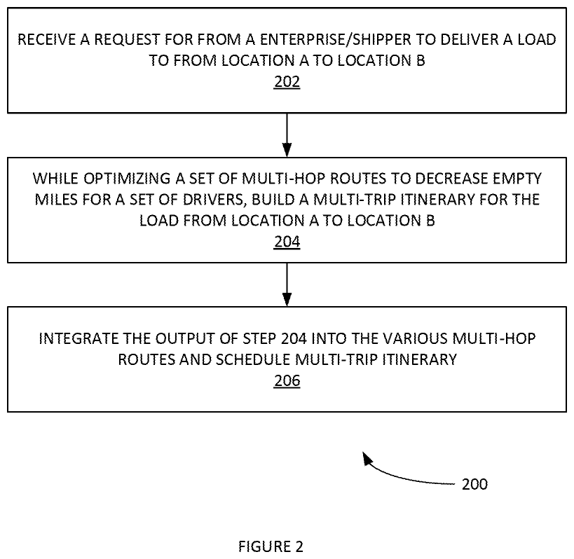

FIG. 2 illustrates an example process 200 for implementing a multi-trip itinerary through multiple drivers, according to some embodiments. In step 202, process 200 can receive a request for from an enterprise/shipper to deliver a load to from location A to location B. In step 204, process 200 can, while optimizing a set of multi-hop routes to decrease empty miles for a set of drivers, build a multi-trip itinerary for the load from location A to location B. In step 206, process 200 can integrate the output of step 204 into the various multi-hop routes and schedule multi-trip itinerary.

In one example of process 200 a customer (e.g. enterprise/shipper) provides request for a load be picked up from location A and delivered to location B. The distance between the locations can be 2000 miles. Instead of assigning a single truck driver/truck/trailer to this load, process 200 can break this delivery route in the following fashion: Assign Driver (D1), Truck (Tk1) and Trailer (Tr1) from A to X1—500 miles; Assign Driver (D2), Truck (Tk2) and Trailer (Tr1 or Tr2) from X1 to X2—500 miles; Assign Driver (D3), Truck (Tk3) and Trailer (Tr1 or Tr2 or Tr3) from X2 to X3—500 miles; Assign Driver (D4), Truck (Tk4) and Trailer (Tr1 or Tr2 or Tr3 or Tr4) from X3 to B—500 miles. This is provided by way of example and not of limitation.

Example Systems

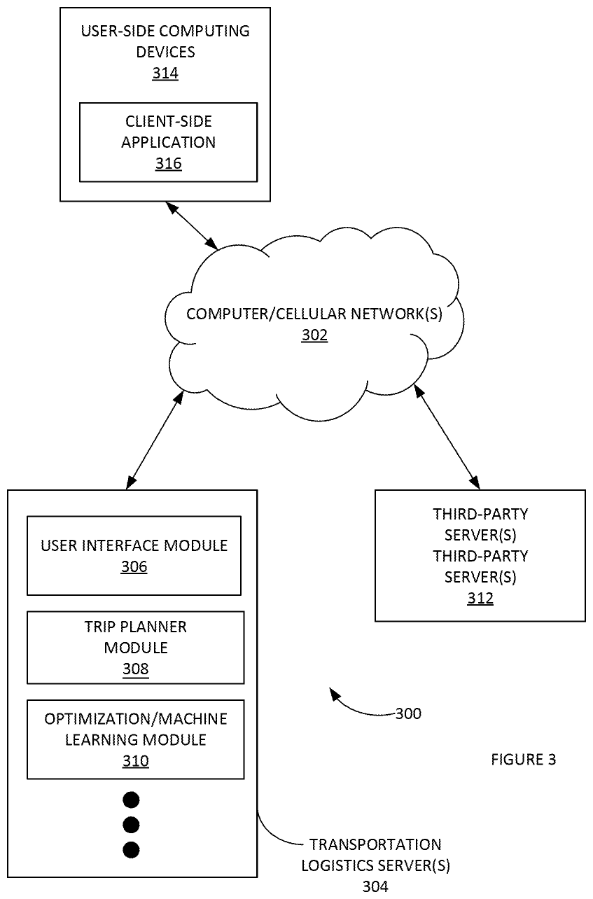

FIG. 3 illustrates an example transportation logistics system 300, according to some embodiments. Transportation logistics system 300 is a computerized system and includes/utilized various computer/cellular networks 302.

Transportation logistics server(s) 204 can implement the various processes provided herein (e.g. process 100, process 200, etc.). Additionally, transportation logistics server(s) 204 can provide Transportation as a Service (TaaS)/Logistics as a Service (LaaS). Accordingly, Transportation logistics server(s) 204 can include a TaaS and/or a LaaS platform(s). The TaaS/LaaS platform(s) can have the following capabilities packaged as webservices. These webservices can seamlessly integrate with various other enterprise software (e.g. a TMS (Transportation Management System), WMS (Warehouse Management Systems) and/or YMS (Yard Management System and RaaS (Routing as a Service) The TaaS/LaaS platform(s) can optimize a route for a truck driver).

Transportation logistics server(s) 204 can implement a Pricing as a Service (PaaS) platform. PaaS can quote the recommended price for a load given such parameters as, inter alia: origin, destination, commodity, eight and other load parameters.

Transportation logistics server(s) 204 can implement Checking as a Service platform. This platform can communicate ETA pings real time to any subscriber (e.g. including third-party enterprise software. Transportation logistics server(s) 204 can implement a Loading as a Service platform. This platform can dictate how a trailer (and/or other load container) is to be loaded in order to achieve maximum efficiencies.

Transportation logistics server(s) 204 can provide a Brokerage as a Service (BaaS) platform. The BaaS platform can provide a solution for brokers as a Brokerage as a Service (BaaS). BaaS can be a subscription-based web portal and/or mobile application (e.g. see client-side application 316, etc.). This can enable traditional brokers to digitalize themselves by leveraging the benefits offered by Transportation logistics server(s) 204 BaaS capabilities. These can include, inter alia: create load for their customers (e.g. using the portal or via other channels such as APIs, EDI, webservices, webhooks, etc.); manage load lifecycle for all the customers including status changes; real time freight tracking; smart monitoring alerts; push notifications; communicating to the customers; automated invoicing to their customers; automated payments to their carriers (e.g. trucking companies, owner operators, autonomous trucks companies, freight drones companies); receive digital copies of BOL (Bill of Lading); POD (Proof of Delivery); signatures etc. from the carriers and passing those on to the customers; OCR based BOL, POD scanning and data extractions and parsing; etc.

Transportation logistics server(s) 204 can provide/manage embedded software for autonomous trucks and freight drones OEMs (Original equipment manufacturer). An example is now provided. An autonomous truck can be manufactured and drives out of the factory. The autonomous truck can be programmed to drive to a specified destination and to pick up a first load and start the multi trip itinerary. The transportation logistics server(s) 204 can provide/manage the guidance/control software that is installed/embedded in it. This software for autonomous trucks OEMs as well as for freight drones. This can enable these OEMs to unlock “digital freight brokerage” capabilities. This can be used as a revenue stream for these OEMs. The OEM can continue to monetize on the autonomous truck throughout its lifecycle. The autonomous truck and pick up the load locally and takes to a nearby port. The autonomous truck can then unload to a ship that is then routed to another seaport (e.g. Los Angeles, Calif.). There, the load is picked up by a drayage/inter-modal provider. It is then distributed again across America through autonomous trucks or freight drones. The end customer and/or any stakeholder (e.g. shipper, receiver, broker, etc.) can have extreme visibility of all of this freight in an end-to-end manner through the services provided by the transportation logistics server(s) 204. Accordingly, Transportation logistics server(s) 204 can include the various functionalities powered by, inter alia: data science, machine learning, artificial intelligence and optimization algorithms running on a platform of Blockchain.

In addition to implementing the above services, transportation logistics server(s) 204 can provide/include various modules for implementing transportation services. Transportation logistics server(s) 204 can include a user interface module 306. User interface module 306 can manage a client-side application 316. User interface module 306 can provide relevant information to a mobile application. User interface module 306 can receive user input and interface with the appropriate systems of transportation logistics server(s) 204. User interface module 306 can receive minimum inputs to a trip planner (e.g. an origin and destination); place and a date and time of travel; etc. User interface module 306 can provide various methods to discover and specify an origin or destination. This can include, inter alia: a location name; a geocoded place; a stop or station code; a street address; a point of interest; a spatial coordinate; etc. User interface module 306 can provide location finding function of a trip planner. This can be used to resolve the origin and destination into a set of known nodes on the transport network. This data can be provided to Trip planner module 308 to compute a trip plan over its data set of known public transport journeys.

Trip planner module 308 can include a journey planning engine and the data sets which are available to it. Trip planner module 308 can use the user inputs to determine the specified parameters of a load journey. (e.g. which transport modes to include or exclude; wait times, costs; routes; etc.). Trip planner module 308 can constrain the time of travel by arrival time, departure time and/or to allow a flexible window within which travel may be undertaken. Trip planner module 308 can provide a preferred routing for the trip via intermediate stop points. Trip planner module 308 can provide trip optimization parameters (e.g. shortest trip, trip with fewest changes, etc.). Trip planner module 308 can include a web mapping service. Web mapping service outputs can be provided to end users as well. Trip planner module 308 can obtain relevant digital maps, satellite imagery, aerial photography, street maps, 360° panoramic views of streets, real-time traffic conditions, and route planning, etc.

Trip planner module 308 can also output a set/list of planned trips and/or planned trip parameters for a user to choose from. These parameters can be displayed on a map. Trip planner module 308 can obtain data from third-party server(s). This can be geo-spatial data, web mapping service data, traffic data, port data, air flight data, cargo ship data, weather data, road condition data, law enforcement data, e-commerce data/services, etc. Trip planner module 308 can provide the times and departure points of trips from stops or stations, with the exact platform to use and even the boarding point on the platform. Trip planner module 308 can provide trip maps showing the path of the trip legs on a map. Trip planner module 308 can provide route maps showing the network topology. Trip planner module 308 can provide stop area maps and other directions to identify the location of the stops at the boarding and alighting points. Trip planner module 308 can provide information on the transfer times needed to make the access and connection legs. Trip planner module 308 can step by step directions in order to follow an access leg to a stop, enter a station or large interchange such as an airport, or make a transfer on a connection leg, including the accessibility characteristics of each step. These outputs can be formatted for display and displayed by the user interface module (e.g. using a mobile-device application, etc.).

Trip planner can include various travel mode specific considerations. Trip planner module can include a path finding functionality. For example, Trip planner module can determine a shortest route between two points (e.g. using a Dijkstra's algorithm, weighted graphs, etc.). Trip planner can use machine learning to optimize routes, delivery schedules, a load-route segmentation and sequence, etc. Trip planner module 308 can provide data to optimization/machine learning module 310.

Optimization/machine learning module 310 can determine the optimal parameters of trips/routes/drivers. Optimization/machine learning module 310 use machine learning methods of historical training data to improve optimizations.

Additional Computing Systems

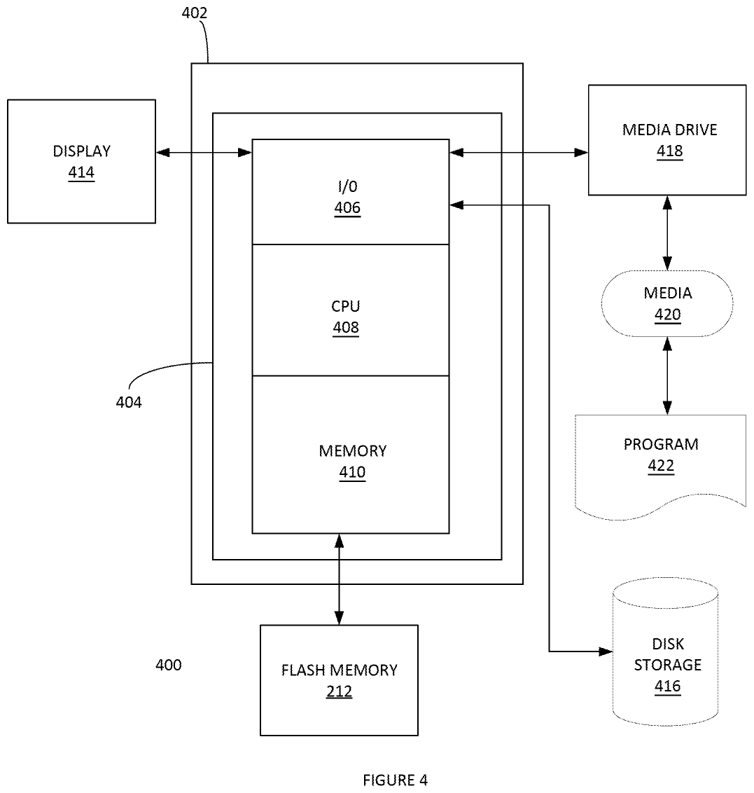

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The 1/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Additional Processes

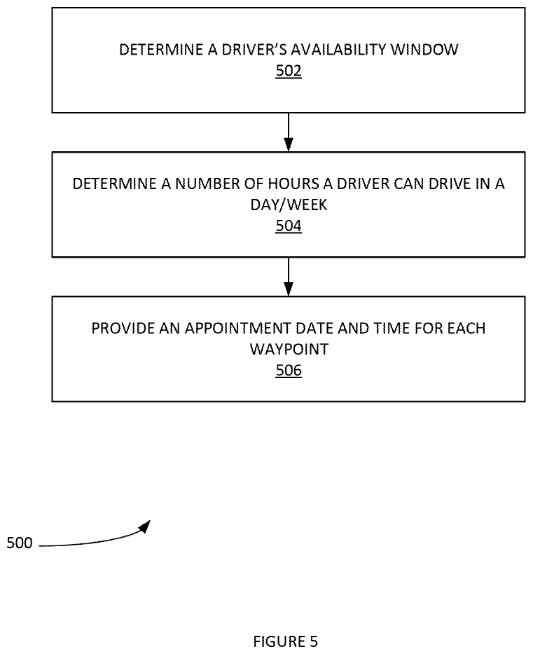

FIG. 5 illustrates an example process 500 for route optimization for load transport, according to some embodiments. In step 502, process 500 can determine a driver's availability window. It is noted that as used herein, ‘driver’ can include Carrier Company and Drivers, etc. The driver's availability window can include a start and end date and time. In step 504, process 500 can determine a number of hours a driver can drive in a day/week (i.e. Hours of Service (HOS) regulation by FMCSA). In step 506, process 500 can provide an appointment date and time for each waypoint (e.g. pick or drop facility).

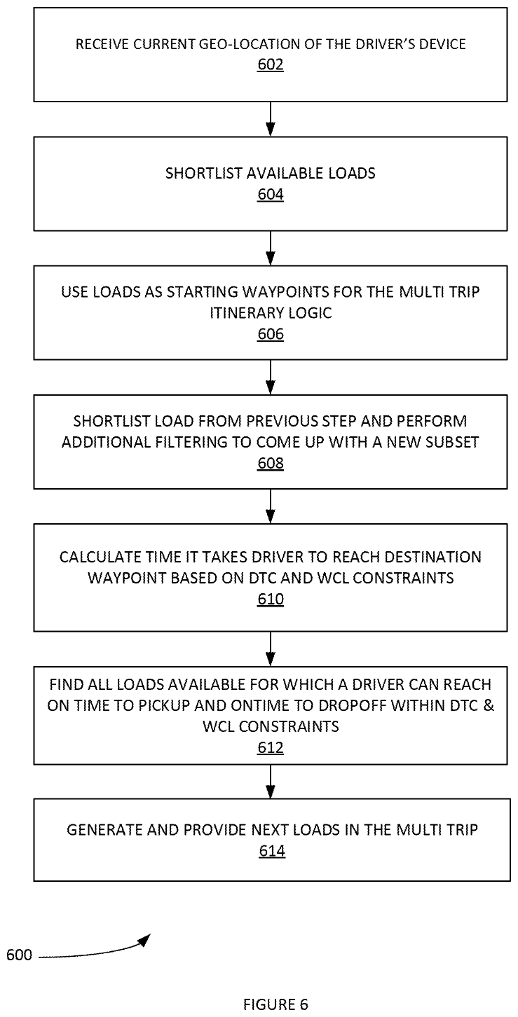

FIG. 6 illustrates another example process 600 for route optimization for load transport, according to some embodiments. In step 602, process 600 receives the current geo-location of the Driver's device (e.g. using a mobile device application, third-party devices, etc.) or Carriers device (e.g. using a mobile device application and/or web portal), NDDWD and DLP. In step 604, process 600 generates a shortlist available loads. Based on the geo-location of the device, process 600 can find out all loads available for pickup based on, inter alia, the following example criteria: within 100 miles (and/or any other distance selected by the user) of driver's current geo location; and/or meet's CLTP criteria.

In step 606, process 600 can use these load as the starting waypoints for the multi trip itinerary logic. Process 600 can shortlist load from previous step and perform additional filtering to come up with a new subset.

In step 608, process 600 can shortlist load from previous step and perform additional filtering to come up with a new subset. As used, herein a Shortlist can be a subset of load we would get after applying a criteria/rule to filter out and find out the subset of loads that will be used in the next step of rules processing. In one example, a ‘Shortlist’ can be a list of loads matching the specific criteria or a rule and as such with every rule that gets applied in the order as dictated by the algorithm. The list of loads will be reduced to a small set with each application of a rule.

In step 610, process 600 can then calculate the time it will take the driver to reach the destination waypoint based on DTC and WCL constraints.

In step 612, once the shortlist of step 610 is determined, process 600 can find/locate all loads available for which a driver can reach on time to pick up and on time to drop off within the DTC and WCL constraints.

Process 600 can find next loads in a multi trip as well in step 614. Process 600 can execute recursive logic until it determines possible combinations of loads that that fall within the drivers availability (NDDQD), DLP, DTC, WCL, MRPM and MTR constraints. All of the multi trip options generated by the above logic can be available for the carriers and driver to select from. Processes 500 and 600 can use machine learning methods to optimize various relevant steps.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

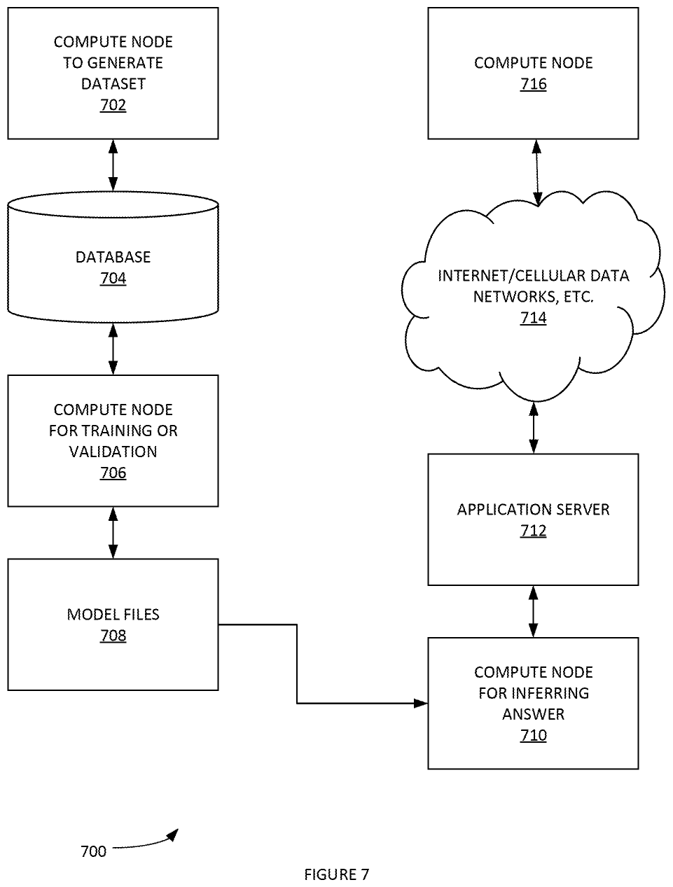

FIG. 7 is a schematic representation of an exemplary hardware environment 100. The hardware environment 100 includes a first compute node 110 that is employed to generate and obtain historical (e.g. non-synthetic data) and/or modeled (e.g. synthetic data) container vehicle route and travel data to build a dataset. In various embodiments the compute node 702 can be a server but can be any computing device with sufficient computing capacity such as a server, personal computer, or smart phone. The compute node 702 can integrate the synthetic and non-synthetic data into a single data set use to train a route-optimization model. The generated data model can include a dataset of multiple carrier profiles, load profiles, route profiles, etc. These profiles can include, inter alia: geolocation (latitude/longitude) of driver (GLD) associated with a set of carrier profiles; a set of load types; a set of carrier's load type preferences (CLTP); a set of a number of days driver wants to drive (NDDWD); a set of minimum rate per mile for the entire multi trip itinerary (MRPM) and/or minimum total revenue for the entire multi trip itinerary (MTR) that a set of drivers wish to receive; a set of weather conditions within a specified configurable radius of the load pick address (WCP); a set of weather conditions within a specified configurable radius of the load drop off address (WCD); etc.

The compute node 702 stores the dataset to a database 704. A second compute node 706, which can be the same compute node as first compute node 702, in some embodiments, accesses the database 704 in order to utilize the dataset to train deep learning models to produced trained model files 708. The second compute node 704 can optionally also validate deep learning models.

A user employing a third compute node 710 can upload GLD, NDDWD, CLTP, NDDWD, MRPM, MTR, WCP, WCD and/or various other route planning information, to an application server 712 across a network like the Internet 170, where the application server 712 hosts a route optimization engine. In response to a request from the compute node 716, such as a mobile phone or PC, to find an optimized route (e.g. based on GLD, NDDWD, CLTP, NDDWD, MRPM, MTR, WCP, WCD, etc.), the application server 712 connects the third compute node 716 to a fourth compute node 710, which can be the same compute node as either the first or second compute nodes 702, 706, in some embodiments. Compute node 710 uses the model files 708 to infer answers to the queries posed by the compute node 716 and transmits the answers back through the application server 712 to the compute node 716.

Driving Time Criterion (DTC) is now discussed. The systems and methods provided herein can obtain the following information about drivers available to drive for today and for the entire week. This can be used to ensure that the driver is adhering to hours of service (HOS) regulation by FMCSA, as well, assist with the calculation of ETA to drop off location. The systems and methods provided herein can be used to determine a pickup appointment time. The systems and methods provided herein can determine a load drop off appointment time. They can also consider all necessary breaks to be taken by driver and is adhering to Hours of Service (HOS) regulation by FMCSA.

Weather Criterion (WCL) are now discussed. WCL can include, inter alia: WCP, WCD or WCR can be used to decide if conditions are sufficiently safe for the driver to drive in the weather conditions. If not drivable, the load cannot be serviced by a driver. If weather conditions do permit, the systems and methods used herein can determine the maximum speed at which the driver should drive to ensure safety of driver and the safety of equipment and the load.

In one embodiments, a process can provide suggestions when it finds the load might be delayed because of bad weather. The process can take into account WCP, WCD and/or WSR and provide suggestions as follows incase weather is below a specified threshold (e.g. bad weather such as: rain, blizzard, etc.). The process can determine an alternative route to ensure on time for pick or drop. The process can suggest a trip or load be hauled by a team (e.g. two or more drivers) instead of a single driver and/or an autonomous truck for a specific load or loads to enable on-time pick-up or drop off a load.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A method comprising:
receiving a current geo-location of a driver's device;
determining a set of available loads for a driver to haul on a specified route;
using the set of available loads as a set of starting waypoints for a multi trip itinerary to determine a subset of loads of the set of available loads;
providing a set of Driving Time Criterion (DTC) and Weather Criterion (WCL) constraints;
calculating a driving time for the driver to reach a specified destination waypoint based on the set of DTC and WCL constraints;
determining all loads available for which the driver is able to perform an on time pickup and on time to drop off within the set of DTC and WCL constraints; and
generating an optimized route of a multi-trip itinerary for the driver to follow to perform the on time pickup and on time to drop off within the set of DTC and WCL constraints.

2. The method of claim 1, wherein the driver uses a self-driving truck to perform the on time pickup and on time to drop off within the set of DTC and WCL constraints.

3. The method of claim 1, wherein the set of DTC and WCL constraints comprises:
a set of hours of service (HOS) regulation provided by Federal Motor Carrier Safety Administration (FMCSA).

4. The method of claim 1, wherein the HOS are used in a calculation of an estimated time of arrival of the driver to the drop off location.

5. The method of claim 1, wherein the set of DTC and WCL constraints comprises:

6. The method of claim 1, wherein the optimized route of the multi-trip itinerary is determined based on a latitude/longitude geolocation of the driver.

7. The method of claim 6, wherein the optimized route of the multi-trip itinerary is determined based on driver's load type preferences (CLTP) and a type of driver's truck equipment.

8. The method of claim 7, wherein the type of driver's truck equipment comprises a reefer truck, dry van truck, or flatbed truck.

9. The method of claim 6, wherein the optimized route of the multi-trip itinerary is determined based on a number of days driver wants to drive (NDDWD).

10. The method of claim 9, wherein the optimized route of the multi-trip itinerary is determined based on a minimum rate per mile for the entire multi trip itinerary (MRPM).

11. The method of claim 9, wherein the optimized route of the multi-trip itinerary is determined based on a minimum total revenue for the entire multi trip itinerary (MTR).

12. The method of claim 11, wherein the optimized route of the multi-trip itinerary is determined based on a set of weather conditions within a specified configurable radius of the load pick address (WCP).

13. The method of claim 11, wherein the optimized route of the multi-trip itinerary is determined based on a set of weather conditions within a specified configurable radius of the load drop off address (WCD).
